(19) United States
(12) Patent Application Publication
(10) Pub. No.: US 2026/0121304 A1
(43) Pub. Date: Apr. 30, 2026

(54) HIGH-GAIN MILLIMETER WAVE ANTENNA STRUCTURE AND MILLIMETER WAVE ANTENNA MODULE THEREOF

(71) Applicant: INPAQ TECHNOLOGY CO., LTD., MIAOLI COUNTY (TW)

(72) Inventors: TA-FU CHENG, MIAOLI COUNTY (TW); CHENG-YI WANG, New Taipei City (TW)

(21) Appl. No.: 19/015,551

(22) Filed: Jan. 9, 2025

(30) Foreign Application Priority Data
Oct. 30, 2024 (TW) 113141413

(51) Int. Cl. H01Q 21/06; H01Q 15/16; H01Q 19/06

(52) U.S. Cl. CPC H01Q 21/065; H01Q 15/16; H01Q 19/06

(57) ABSTRACT

A high-gain millimeter wave antenna structure and a millimeter wave antenna module. The high-gain millimeter wave antenna structure includes a first reflective plate, a second reflective plate and a millimeter wave antenna module disposed between the first and the second reflective plates. When the millimeter wave antenna module is configured to provide an original millimeter wave signal, the original millimeter wave signal provided by the millimeter wave antenna module is reflected by the first and the second reflective plates in sequence to form an operating millimeter wave signal transmitted in a same predetermined direction. Therefore, an operating antenna gain of the operating millimeter wave signal provided by the cooperation of the millimeter wave antenna module, the first reflective plate and the second reflective plate is greater than an original antenna gain of the original millimeter wave signal provided by the millimeter wave antenna module.

### CROSS-REFERENCE TO RELATED PATENT APPLICATION

This application claims the benefit of priority to Taiwan Patent Application No. 113141413, filed on Oct. 30, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna structure and an antenna module thereof, and more particularly to a high-gain millimeter wave antenna structure and a millimeter wave antenna module thereof.

### BACKGROUND OF THE DISCLOSURE

In the related art, a millimeter wave antenna module uses a large number or huge number of antenna arrays. When a large number or huge number of antenna arrays form a beam, the half-power beamwidth of the beam becomes narrower with the number of antenna units in the antenna array. The bandwidth of the millimeter wave frequency is quite sufficient and can be used to compensate for the transmission loss of the outdoor high-frequency communications and can also achieve high transmission rates. However, the millimeter wave antenna modules in the related art still have room for improvement.

### SUMMARY OF THE DISCLOSURE

In response to the above-referenced technical inadequacy, the present disclosure provides a high-gain millimeter wave antenna structure and a millimeter wave antenna module thereof. When the millimeter wave antenna module is configured to optionally provide an original millimeter wave signal, the original millimeter wave signal provided by the millimeter wave antenna module can be reflected by the first reflective plate and the second reflective plate in sequence to form an operating millimeter wave signal transmitted in a same predetermined direction.

In order to solve the above-mentioned problems, one of the technical aspects adopted by the present disclosure is to provide a high-gain millimeter wave antenna structure, which includes a first reflective plate having a first recessed area, a second reflective plate having a second recessed area, and a millimeter wave antenna module disposed between the first reflective plate and the second reflective plate. The first reflective plate and the second reflective plate are arranged correspondingly, the first recessed area of the first reflective plate is smaller than the second recessed area of the second reflective plate, and the first recessed area of the first reflective plate faces the second recessed area of the second reflective plate. The first reflective plate has a first focusing area, and the millimeter wave antenna module is disposed within the first focusing area of the first reflective plate. The second reflective plate has a second focusing area, and the first reflective plate is disposed within the second focusing area of the second reflective plate. When the millimeter wave antenna module is configured to optionally provide an original millimeter wave signal, the original millimeter wave signal provided by the millimeter wave antenna module is reflected by the first reflective plate and the second reflective plate in sequence to form an operating millimeter wave signal transmitted in a same predetermined direction. An operating antenna gain of the operating millimeter wave signal provided by the cooperation of the millimeter wave antenna module, the first reflective plate and the second reflective plate is greater than an original antenna gain of the original millimeter wave signal provided by the millimeter wave antenna module.

In order to solve the above-mentioned problems, another one of the technical aspects adopted by the present disclosure is to provide a high-gain millimeter wave antenna structure, which includes a first reflective plate having a first recessed area, a second reflective plate having a second recessed area, and a millimeter wave antenna module disposed between the first reflective plate and the second reflective plate. The first reflective plate and the second reflective plate are arranged correspondingly, the first recessed area of the first reflective plate is smaller than the second recessed area of the second reflective plate, and the first recessed area of the first reflective plate faces the second recessed area of the second reflective plate. The first reflective plate has a first focusing area, and the second reflective plate has a second focusing area. An operating antenna gain of an operating millimeter wave signal provided by the cooperation of the millimeter wave antenna module, the first reflective plate and the second reflective plate is greater than an original antenna gain of an original millimeter wave signal provided by the millimeter wave antenna module.

In order to solve the above-mentioned problems, yet another one of the technical aspects adopted by the present disclosure is to provide a millimeter wave antenna module, which includes a millimeter wave antenna and at least one focusing lens, in which the millimeter wave antenna is disposed within a first lens focusing area of the at least one focusing lens.

Therefore, in the high-gain millimeter wave antenna structure provided by the present disclosure, by virtue of “the millimeter wave antenna module being disposed between the first reflective plate and the second reflective plate,” “the first recessed area of the first reflective plate being smaller than the second recessed area of the second reflective plate,” “the first recessed area of the first reflective plate facing the second recessed area of the second reflective plate,” “the first reflective plate having a first focusing area” and “the second reflective plate having a second focusing area,” when the millimeter wave antenna module is configured to optionally provide an original millimeter wave signal, the original millimeter wave signal provided by the millimeter wave antenna module can be reflected by the first reflective plate and the second reflective plate in sequence to form an operating millimeter wave signal transmitted in a same predetermined direction. It should be noted that an operating antenna gain of the operating millimeter wave signal provided by the cooperation of the millimeter wave antenna module, the first reflective plate and the second reflective plate can be greater than an original antenna gain of the original millimeter wave signal provided by the millimeter wave antenna module.

Furthermore, in the high-gain millimeter wave antenna structure provided by the present disclosure, by virtue of “the millimeter wave antenna module including a millimeter wave antenna and at least one focusing lens” and “the millimeter wave antenna is disposed within a first lens focusing area of the at least one focusing lens,” when the antenna array module of the millimeter wave antenna module is configured to optionally provide an original millimeter wave signal, the original millimeter wave signal provided by the millimeter wave antenna module can pass through the at least one focusing lens. Therefore, the original millimeter wave signal provided by the millimeter wave antenna module through the cooperation of the millimeter wave antenna and the at least one focusing lens can be reflected by the first reflective plate and the second reflective plate in sequence to form an operating millimeter wave signal transmitted in a same predetermined direction. It should be noted that an operating antenna gain of the operating millimeter wave signal provided by the cooperation of the millimeter wave antenna module, the first reflective plate and the second reflective plate can be greater than an original antenna gain of the original millimeter wave signal provided by the millimeter wave antenna module.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a high-gain millimeter wave antenna structure provided by a first embodiment of the present disclosure;

FIG. 2 is a schematic perspective view of a first reflective plate of the high-gain millimeter wave antenna structure provided by the first embodiment of the present disclosure;

FIG. 3 is a schematic cross-sectional view of the high-gain millimeter wave antenna structure provided by the first embodiment of the present disclosure;

FIG. 4 is a schematic optical path view of the high-gain millimeter wave antenna structure provided by the first embodiment of the present disclosure;

FIG. 5 is a schematic perspective view of the high-gain millimeter wave antenna structure provided by the second embodiment of the present disclosure;

FIG. 6 is a schematic perspective view of the first reflective plate of the high-gain millimeter wave antenna structure provided by a second embodiment of the present disclosure;

FIG. 7 is a schematic cross-sectional view of the high-gain millimeter wave antenna structure provided by the second embodiment of the present disclosure; and

FIG. 8 is a schematic optical path view of the high-gain millimeter wave antenna structure provided by the second embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

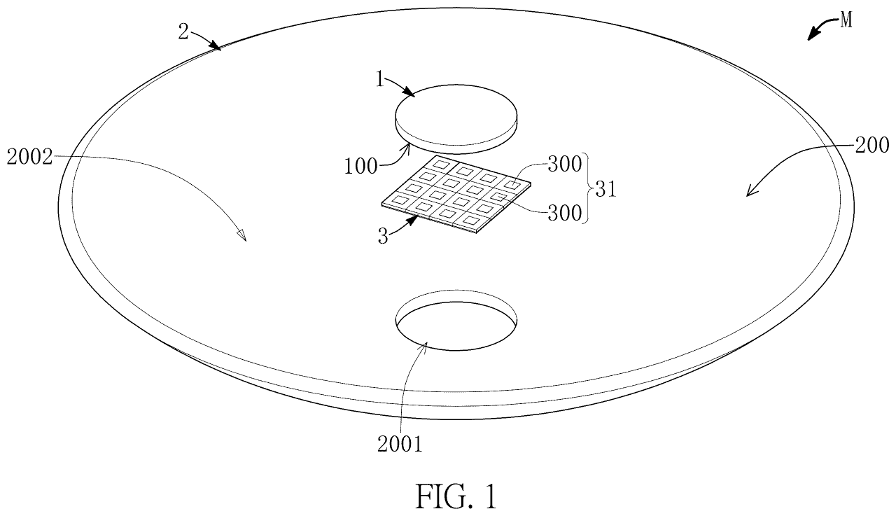

Referring to FIG. 1 to FIG. 4, a first embodiment of the present disclosure provides a high-gain millimeter wave antenna structure M, which includes a first reflective plate 1 (or a first antenna signal reflector), a second reflective plate 2 (or a second antenna signal reflector) and a millimeter wave antenna module 3. More particularly, the first reflective plate 1 has a first recessed area 100 (or a first concave area), the second reflective plate 2 has a second recessed area 200 (or a second concave area), and the millimeter wave antenna module 3 can be disposed between the first reflective plate 1 and the second reflective plate 2. In addition, the first reflective plate 1 and the second reflective plate 2 can be arranged correspondingly, the first recessed area 100 of the first reflective plate 1 can be smaller than the second recessed area 200 of the second reflective plate 2, and the first recessed area 100 of the first reflective plate 1 can face the second recessed area 200 of the second reflective plate 2.

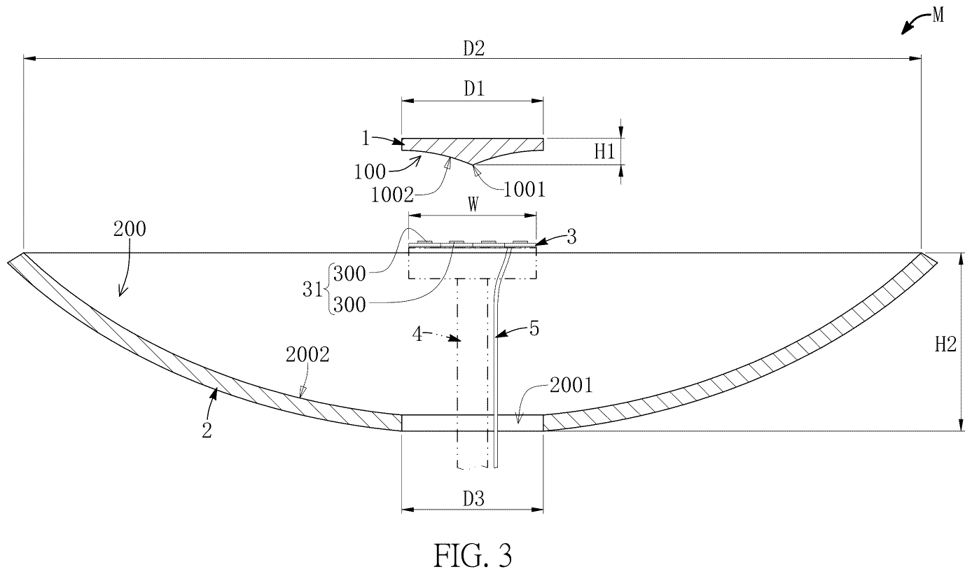

For example, referring to FIG. 1 and FIG. 3, the first reflective plate 1 has a first focusing area, and according to different requirements, the millimeter wave antenna module 3 can be disposed within the first focusing area of the first reflective plate 1 (that is to say, the first focusing area is not just one point, but a range that can cover a predetermined space), or adjacent to the first focusing area of the first reflective plate 1 (that is to say, the millimeter wave antenna module 3 may be completely or partially disposed within the first focusing area of the first reflective plate 1, or the millimeter wave antenna module 3 may not be disposed within the first focusing area of the first reflective plate 1 at all). In addition, the second reflective plate 2 has a second focusing area, and according to different requirements, the first reflective plate 1 can be disposed within the second focusing area of the second reflective plate 2 (that is to say, the second focusing area is not just one point, but a range that can cover a predetermined space), or adjacent to the second focusing area of the second reflective plate 2 (that is to say, the second reflective plate 2 may be completely or partially disposed within the second focusing area of the second reflective plate 2, or the second reflective plate 2 may not be disposed within the second focusing area of the second reflective plate 2 at all). However, the aforementioned details are disclosed for exemplary purposes only, and are not meant to limit the scope of the present disclosure.

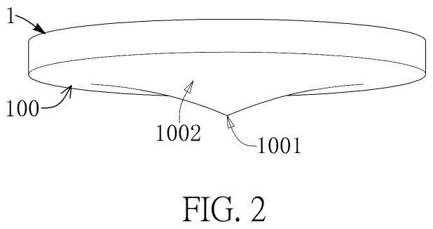

For example, referring to FIG. 1, FIG. 2 and FIG. 3, the first recessed area 100 of the first reflective plate 1 has a protruding tip portion 1001 (or a central protrusion) and a first signal reflective surface 1002 (or a first surrounding reflective surface) surrounding the protruding tip portion 1001. In addition, the second reflective plate 2 has a through opening 2001 (such as a circular opening, a polygonal opening or an arbitrary shaped opening) connected to (or communicated with) the second recessed area 200, and the second recessed area 200 of the second reflective plate 2 has a second signal reflective surface 2002 (or a second surrounding reflective surface) surrounding the through opening 2001. It should be noted that the first signal reflective surface 1002 of the first recessed area 100 of the first reflective plate 1 may have a first focusing area, and the second signal reflective surface 2002 of the second recessed area 200 of the second reflective plate 2 may have a second focus area. More particularly, the first reflective plate 1 has a first diameter D1 between 10 mm and 40 mm (such as any positive integer between 10 mm and 40 mm) and a first height H1 between 20 mm and 80 mm (such as any positive integer between 20 mm and 80 mm), and the second reflective plate 2 has a second diameter D2 between 100 mm and 200 mm (such as any positive integer between 100 mm and 200 mm) and a second height H2 between 20 mm and 80 mm (such as any positive integer between 20 mm and 80 mm). In addition, the first reflective plate 1 and the second reflective plate 2 can be supported or positioned through any supporting structure or any carrying structure. However, the aforementioned details are disclosed for exemplary purposes only, and are not meant to limit the scope of the present disclosure.

For example, referring to FIG. 1 and FIG. 3, the millimeter wave antenna module 3 can be configured as an antenna array module 31, the antenna array module 31 may include a plurality of microstrip patch antenna units 300 arranged in a predetermined array shape (such as a 4×4 array, or an array of any number of columns) or a plurality of microstrip patch antennas, and according to different requirements, the antenna array module 31 can be disposed within the first focusing area of the first reflective plate 1 or adjacent to the first focusing area of the first reflective plate 1. It should be noted that the millimeter wave antenna module 3 can be disposed outside the second recessed area 200 of the second reflective plate 2 (that is to say, the millimeter wave antenna module 3 will not be surrounded by the second reflective plate 2 at all), and the millimeter wave antenna module 3 can be supported by an antenna carrier structure 4 (or an antenna carrying structure can use low dielectric constant materials and reduce the occupied volume, thereby reducing the problem of multiple reflections or diffraction of signals) to be disposed between the first reflective plate 1 and the second reflective plate 2. In one of the feasible embodiments, according to different requirements, the millimeter wave antenna module 3 can also be installed at the bottom of the second reflective plate 2 or at a position beyond the bottom of the second reflective plate 2. In addition, the antenna carrier structure 4 can pass through the through opening 2001 of the second reflective plate 2 to guide (or not guide) a coaxial cable 5 (or an antenna signal transmission line) that is electrically connected to the millimeter wave antenna module 3, and the millimeter wave antenna module 3 can be electrically connected to a circuit substrate (not shown) or an electronic chip (not shown) through the coaxial cable 5. More particularly, the second diameter D2 of the second reflective plate 2 can be greater than the first diameter D1 of the first reflective plate 1, and the first diameter D1 of the first reflective plate 1 can be greater than or equal to a maximum width W (or a maximum length) of the millimeter wave antenna module 3, and the maximum width W of the millimeter wave antenna module 3 can be greater than, equal to, or less than an opening diameter D3 of the through opening 2001 of the second reflective plate 2. However, the aforementioned details are disclosed for exemplary purposes only, and are not meant to limit the scope of the present disclosure.

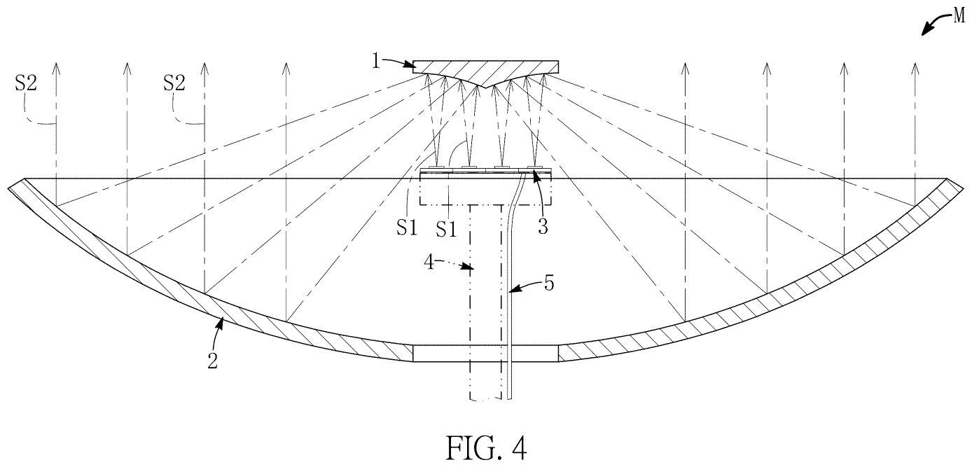

Therefore, referring to FIG. 3 and FIG. 4, when the millimeter wave antenna module 3 (such as the antenna array module 31 including multiple microstrip patch antenna units 300) can be configured to optionally provide an original millimeter wave signal S1 (or an initial radio frequency wave, or an initial antenna beam), the original millimeter wave signal S1 provided by the millimeter wave antenna module 3 can be reflected by the first reflective plate 1 and the second reflective plate 2 in sequence to form an operating millimeter wave signal S2 (or multiple working radio frequency waves, or multiple working antenna beams) that can be transmitted in the same predetermined direction. It should be noted that an operating antenna gain (an antenna gain after adjustment) of the operating millimeter wave signal S2 provided by the cooperation of the millimeter wave antenna module 3, the first reflective plate 1 and the second reflective plate 2 can be greater than an original antenna gain (an antenna gain before adjustment) of the original millimeter wave signal S1 provided by the millimeter wave antenna module 3. That is to say, when the antenna array module 31 of the millimeter wave antenna module 3 is configured to optionally provide the original millimeter wave signal S1, the original millimeter wave signal S1 provided by the antenna array module 31 of the millimeter wave antenna module 3 can be reflected by the first signal reflective surface 1002 of the first reflective plate 1 and the second signal reflective surface 2002 of the second reflective plate 2 in sequence to form the operating millimeter wave signal S2 that can be transmitted in the same predetermined direction. For example, a wavelength of the original millimeter wave signal S1 can be between 1 mm and 10 mm (such as any positive integer between 1 mm and 10 mm), and a frequency of the original millimeter wave signal S1 can be between 28 GHz and 300 GHz (such as any positive integer between 28 GHz and 300 GHz). In one of the feasible embodiments, when the frequency of the original millimeter wave signal S1 is set to about 28 GHz, an original antenna gain of the original millimeter wave signal S1 provided by the millimeter wave antenna module 3 (such as using multiple microstrip patch antenna units 300) can reach about 16 dBi, and the operating antenna gain of the operating millimeter wave signal S2 provided by the cooperation of the millimeter wave antenna module 3, the first reflective plate 1 and the second reflective plate 2 can reach about 24 dBi. However, the aforementioned details are disclosed for exemplary purposes only, and are not meant to limit the scope of the present disclosure.

### Second Embodiment

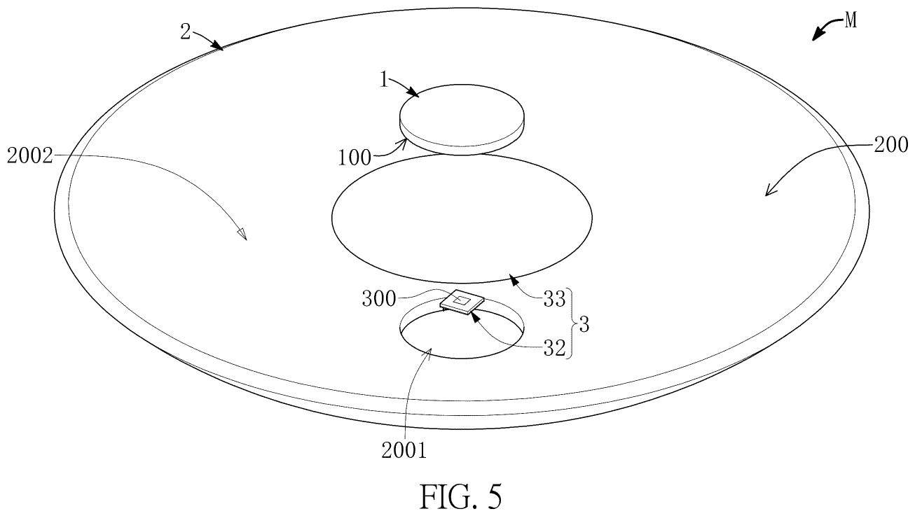

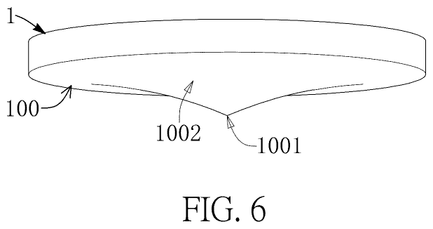

Referring to FIG. 5 to FIG. 8, a second embodiment of the present disclosure provides a high-gain millimeter wave antenna structure M, which includes a first reflective plate 1, a second reflective plate 2 and a millimeter wave antenna module 3. Comparing FIG. 5 to FIG. 8 with FIG. 1 to FIG. 4, respectively, the main difference between the second embodiment and the first embodiment is as follows: in the second embodiment, the millimeter wave antenna module 3 may include a millimeter wave antenna 32 and at least one focusing lens 33, and the millimeter wave antenna 32 may include at least one microstrip patch antenna unit 300 or a single microstrip patch antenna. In addition, the millimeter wave antenna 32 can be disposed between the at least one focusing lens 33 and the second reflective plate 2, and the at least one focusing lens 33 can be disposed between the millimeter wave antenna 32 and the first reflective plate 1.

For example, according to different requirements, the millimeter wave antenna 32 can be disposed within a first lens focusing area of the at least one focusing lens 33 (that is to say, the first lens focusing area is not just one point, but a range that can cover a predetermined space), or adjacent to a first lens focusing area of the at least one focusing lens 33 (that is to say, the millimeter-wave antenna 32 may be completely or partially disposed within a first lens focusing area of the at least one focusing lens 33, or the millimeter wave antenna 32 may not be disposed within a first lens focusing area of the at least one focusing lens 33 at all). In addition, according to different requirements, the first reflective plate 1 can be disposed within a second lens focusing area of the at least one focusing lens 33 (that is to say, the second lens focusing area is not just one point, but a range that can cover a predetermined space), or adjacent to the second lens focusing area of the at least one focus lens 33 (that is to say, the first reflective plate 1 can be completely or partially disposed within the second lens focusing area of the at least one focusing lens 33, or the first reflective plate 1 may not be disposed within a second lens focusing area of the at least one focusing lens 33 at all). It should be noted that the at least one focusing lens 33 (or at least one high dielectric constant lens) can be configured as a ceramic focusing lens, a mica focusing lens, a glass focusing lens, a plastic focusing lens or any kind of high dielectric constant lens, and the present disclosure uses the at least one focusing lens 33 with a high dielectric constant, which can provide the advantages of thin size, small temperature coefficient change, small air gap (small porosity), stable dielectric constant, not easily broken, and high gain. Moreover, the second diameter D2 of the second reflective plate 2 can be greater than or equal to a lens diameter D4 of the at least one focusing lens 33, the lens diameter D4 of the at least one focusing lens 33 can be greater than or equal to the first diameter D1 of the first reflective plate 1, and the at least one focusing lens 33 has a thickness between 1000 μm and 3000 μm (such as any positive integer between 1000 μm and 3000 μm). In addition, the first reflective plate 1, the second reflective plate 2 and the at least one focusing lens 33 can be supported or positioned through any supporting structure or any carrying structure. However, the aforementioned details are disclosed for exemplary purposes only, and are not meant to limit the scope of the present disclosure.

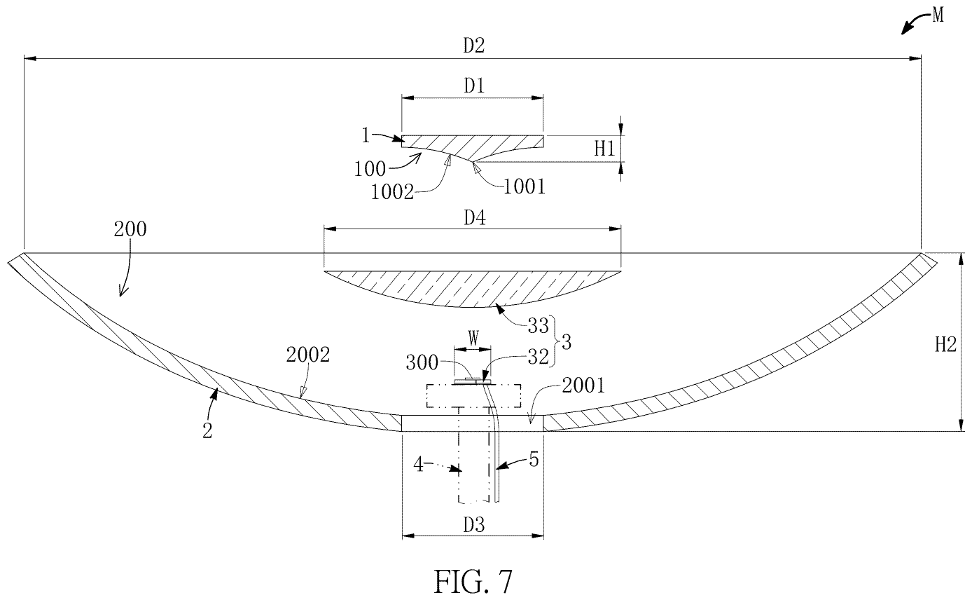

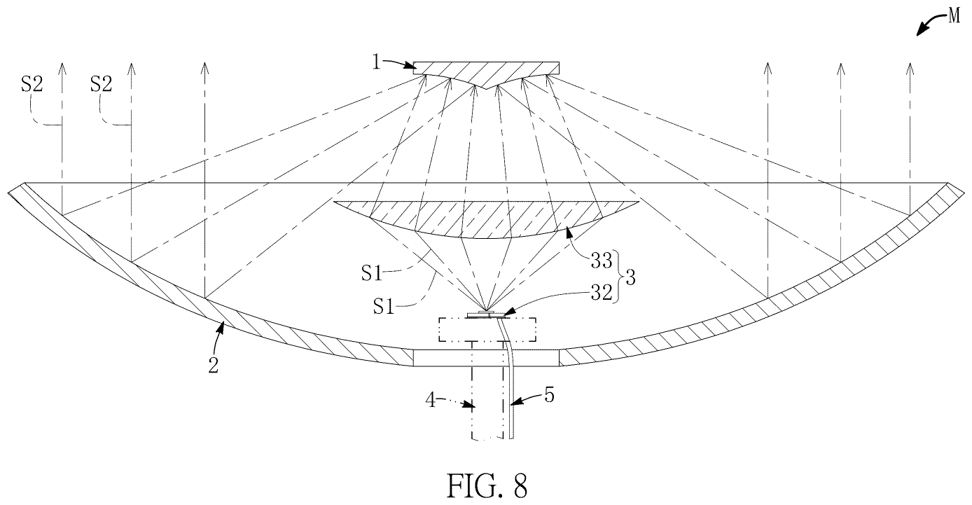

Therefore, referring to FIG. 7 and FIG. 8, when the millimeter wave antenna module 3 (such as the antenna array module 31 including the millimeter wave antenna 32 and the at least one focusing lens 33) can be configured to optionally provide an original millimeter wave signal S1 (or an initial radio frequency wave, or an initial antenna beam), the original millimeter wave signal S1 provided by the millimeter wave antenna module 3 can be reflected by the first reflective plate 1 and the second reflective plate 2 in sequence to form an operating millimeter wave signal S2 (or multiple working radio frequency waves, or multiple working antenna beams) that can be transmitted in the same predetermined direction. It should be noted that an operating antenna gain (an antenna gain after adjustment) of the operating millimeter wave signal S2 provided by the cooperation of the millimeter wave antenna module 3, the first reflective plate 1 and the second reflective plate 2 can be greater than an original antenna gain (an antenna gain before adjustment) of the original millimeter wave signal S1 provided by the millimeter wave antenna module 3. That is to say, when the millimeter wave antenna 32 of the millimeter wave antenna module 3 can be configured to optionally provide the original millimeter wave signal S1, the original millimeter wave signal S1 provided by the millimeter wave antenna 32 of the millimeter wave antenna module 3 can pass through the at least one focusing lens 33 (or can be focused by the at least one focusing lens 33) and be reflected by the first signal reflective surface 1002 of the first reflective plate 1 and the second signal reflective surface 2002 of the second reflective plate 2 in sequence to form the operating millimeter wave signal S2 that can be transmitted in the same predetermined direction. For example, a wavelength of the original millimeter wave signal S1 can be between 1 mm and 10 mm (such as any positive integer between 1 mm and 10 mm), and a frequency of the original millimeter wave signal S1 can be between 28 GHz and 300 GHz (such as any positive integer between 28 GHz and 300 GHz). In one of the feasible embodiments, when the frequency of the original millimeter wave signal S1 is set to about 28 GHz, an original antenna gain of the original millimeter wave signal S1 provided by the millimeter wave antenna module 3 (such as through the cooperation of a single microstrip patch antenna unit 300 and the at least one focusing lens 33) can reach about 16 dBi (it should be noted that the antenna gain of the millimeter wave signal provided by the single microstrip patch antenna unit 300 can reach about 6 dBi), and the operating antenna gain of the operating millimeter wave signal S2 provided by the cooperation of the millimeter wave antenna module 3, the first reflective plate 1 and the second reflective plate 2 can reach about 24 dBi. However, the aforementioned details are disclosed for exemplary purposes only, and are not meant to limit the scope of the present disclosure.

### BENEFICIAL EFFECTS OF THE EMBODIMENTS

In conclusion, in the high-gain millimeter wave antenna structure M provided by the present disclosure, by virtue of “the millimeter wave antenna module 3 being disposed between the first reflective plate 1 and the second reflective plate 2,” “the first recessed area 100 of the first reflective plate 1 being smaller than the second recessed area 200 of the second reflective plate 2,” “the first recessed area 100 of the first reflective plate 1 facing the second recessed area 200 of the second reflective plate 2,” “the first reflective plate 1 having a first focusing area” and “the second reflective plate 2 having a second focusing area,” when the millimeter wave antenna module 3 is configured to optionally provide an original millimeter wave signal S1, the original millimeter wave signal S1 provided by the millimeter wave antenna module 3 can be reflected by the first reflective plate 1 and the second reflective plate 2 in sequence to form an operating millimeter wave signal S2 that can be transmitted in the same predetermined direction. It should be noted that an operating antenna gain of the operating millimeter wave signal S2 provided by the cooperation of the millimeter wave antenna module 3, the first reflective plate 1 and the second reflective plate 2 can be greater than an original antenna gain of the original millimeter wave signal S1 provided by the millimeter wave antenna module 3.

Furthermore, in the high-gain millimeter wave antenna structure M provided by the present disclosure, by virtue of “the millimeter wave antenna module 3 including a millimeter wave antenna 32 and at least one focusing lens 33” and “the millimeter wave antenna 32 being disposed within a first lens focusing area of the at least one focusing lens 33,” when the antenna array module 31 of the millimeter wave antenna module 3 is configured to optionally provide an original millimeter wave signal S1, the original millimeter wave signal S1 provided by the millimeter wave antenna module 3 can pass through the at least one focusing lens 33. Therefore, the original millimeter wave signal S1 provided by the millimeter wave antenna module 3 through the cooperation of the millimeter wave antenna 32 and the at least one focusing lens 33 can be reflected by the first reflective plate 1 and the second reflective plate 2 in sequence to form an operating millimeter wave signal S2 that can be transmitted in the same predetermined direction. It should be noted that an operating antenna gain of the operating millimeter wave signal S2 provided by the cooperation of the millimeter wave antenna module 3, the first reflective plate 1 and the second reflective plate 2 can be greater than an original antenna gain of the original millimeter wave signal S1 provided by the millimeter wave antenna module 3.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A high-gain millimeter wave antenna structure, comprising:
a first reflective plate having a first recessed area;
a second reflective plate having a second recessed area; and
a millimeter wave antenna module disposed between the first reflective plate and the second reflective plate;
wherein the first reflective plate and the second reflective plate are arranged correspondingly, the first recessed area of the first reflective plate is smaller than the second recessed area of the second reflective plate, and the first recessed area of the first reflective plate faces the second recessed area of the second reflective plate;
wherein the first reflective plate has a first focusing area, and the millimeter wave antenna module is disposed within the first focusing area of the first reflective plate;
wherein the second reflective plate has a second focusing area, and the first reflective plate is disposed within the second focusing area of the second reflective plate;
wherein, when the millimeter wave antenna module is configured to optionally provide an original millimeter wave signal, the original millimeter wave signal provided by the millimeter wave antenna module is reflected by the first reflective plate and the second reflective plate in sequence to form an operating millimeter wave signal transmitted in a same predetermined direction; and
wherein an operating antenna gain of the operating millimeter wave signal provided by the cooperation of the millimeter wave antenna module, the first reflective plate and the second reflective plate is greater than an original antenna gain of the original millimeter wave signal provided by the millimeter wave antenna module.

2. The high-gain millimeter wave antenna structure according to claim 1,
wherein the millimeter wave antenna module is configured as an antenna array module, the antenna array module includes a plurality of microstrip patch antenna units arranged in a predetermined array shape, and the antenna array module is disposed within the first focusing area of the first reflective plate;
wherein the first recessed area of the first reflective plate has a protruding tip portion and a first signal reflective surface surrounding the protruding tip portion;
wherein the second reflective plate has a through opening connected to the second recessed area, and the second recessed area of the second reflective plate has a second signal reflective surface surrounding the through opening;
wherein, when the antenna array module of the millimeter wave antenna module is configured to optionally provide the original millimeter wave signal, the original millimeter wave signal provided by the antenna array module of the millimeter wave antenna module is reflected by the first signal reflective surface of the first reflective plate and the second signal reflective surface of the second reflective plate in sequence to form the operating millimeter wave signal transmitted in the same predetermined direction;
wherein the millimeter wave antenna module is disposed outside the second recessed area of the second reflective plate, and the millimeter wave antenna module is supported by an antenna carrier structure to be disposed between the first reflective plate and the second reflective plate;
wherein the antenna carrier structure passes through the through opening of the second reflective plate to guide a coaxial cable that is electrically connected to the millimeter wave antenna module;
wherein a wavelength of the original millimeter wave signal is between 1 mm and 10 mm, and a frequency of the original millimeter wave signal is between 28 GHz and 300 GHz;
wherein the first reflective plate has a first diameter between 10 mm and 40 mm, and a first height between 20 mm and 80 mm;
wherein the second reflective plate has a second diameter between 100 mm and 200 mm, and a second height between 20 mm and 80 mm; and
wherein the second diameter of the second reflective plate is greater than the first diameter of the first reflective plate, and the first diameter of the first reflective plate is greater than or equal to a maximum width of the millimeter wave antenna module, and the maximum width of the millimeter wave antenna module is greater than, equal to, or less than an opening diameter of the through opening of the second reflective plate.

3. The high-gain millimeter wave antenna structure according to claim 1,
wherein the millimeter wave antenna module includes a millimeter wave antenna and at least one focusing lens, and the millimeter wave antenna includes at least one microstrip patch antenna unit;
wherein the millimeter wave antenna is disposed within a first lens focusing area of the at least one focusing lens, and the first reflective plate is disposed within a second lens focusing area of the at least one focusing lens;
wherein the millimeter wave antenna is disposed between the at least one focusing lens and the second reflective plate, and the at least one focusing lens is disposed between the millimeter wave antenna and the first reflective plate;
wherein the at least one focusing lens is configured as a ceramic focusing lens, a mica focusing lens, a glass focusing lens or a plastic focusing lens, and the at least one focusing lens has a thickness between 1000 μm and 3000 μm;
wherein the first recessed area of the first reflective plate has a protruding tip portion and a first signal reflective surface surrounding the protruding tip portion;
wherein the second reflective plate has a through opening connected to the second recessed area, and the second recessed area of the second reflective plate has a second signal reflective surface surrounding the through opening;
wherein, when the antenna array module of the millimeter wave antenna module is configured to optionally provide the original millimeter wave signal, the original millimeter wave signal provided by the millimeter wave antenna module passes through the at least one focusing lens and is reflected by the first signal reflective surface of the first reflective plate and the second signal reflective surface of the second reflective plate in sequence to form the operating millimeter wave signal transmitted in the same predetermined direction;
wherein the millimeter wave antenna module is disposed inside the second recessed area of the second reflective plate, and the millimeter wave antenna module is supported by an antenna carrier structure to be disposed between the first reflective plate and the second reflective plate;
wherein the antenna carrier structure passes through the through opening of the second reflective plate to guide a coaxial cable that is electrically connected to the millimeter wave antenna module;
wherein a wavelength of the original millimeter wave signal is between 1 mm and 10 mm, and a frequency of the original millimeter wave signal is between 28 GHz and 300 GHz;
wherein the first reflective plate has a first diameter between 10 mm and 40 mm, and a first height between 20 mm and 80 mm;
wherein the second reflective plate has a second diameter between 100 mm and 200 mm, and a second height between 20 mm and 80 mm; and
wherein the second diameter of the second reflective plate is greater than a lens diameter of the at least one focusing lens, the lens diameter of the at least one focusing lens is greater than the first diameter of the first reflective plate, the first diameter of the first reflective plate is greater than or equal to a maximum width of the millimeter wave antenna module, and the maximum width of the millimeter wave antenna module is greater than, equal to, or smaller than an opening diameter of the through opening of the second reflective plate.

4. A high-gain millimeter wave antenna structure, comprising:
a first reflective plate having a first recessed area;
a second reflective plate having a second recessed area; and
a millimeter wave antenna module disposed between the first reflective plate and the second reflective plate;
wherein the first reflective plate and the second reflective plate are arranged correspondingly, the first recessed area of the first reflective plate is smaller than the second recessed area of the second reflective plate, and the first recessed area of the first reflective plate faces the second recessed area of the second reflective plate;
wherein the first reflective plate has a first focusing area, and the second reflective plate has a second focusing area; and
wherein an operating antenna gain of an operating millimeter wave signal provided by the cooperation of the millimeter wave antenna module, the first reflective plate and the second reflective plate is greater than an original antenna gain of an original millimeter wave signal provided by the millimeter wave antenna module.

5. The high-gain millimeter wave antenna structure according to claim 4,
wherein the millimeter wave antenna module is configured as an antenna array module, the antenna array module includes a plurality of microstrip patch antenna units arranged in a predetermined array shape, and the antenna array module is disposed within the first focusing area of the first reflective plate;
wherein the first recessed area of the first reflective plate has a protruding tip portion and a first signal reflective surface surrounding the protruding tip portion;
wherein the second reflective plate has a through opening connected to the second recessed area, and the second recessed area of the second reflective plate has a second signal reflective surface surrounding the through opening;
wherein, when the antenna array module of the millimeter wave antenna module is configured to optionally provide the original millimeter wave signal, the original millimeter wave signal provided by the antenna array module of the millimeter wave antenna module is reflected by the first signal reflective surface of the first reflective plate and the second signal reflective surface of the second reflective plate in sequence to form the operating millimeter wave signal transmitted in the same predetermined direction;
wherein the millimeter wave antenna module is disposed outside the second recessed area of the second reflective plate, and the millimeter wave antenna module is supported by an antenna carrier structure to be disposed between the first reflective plate and the second reflective plate;
wherein the antenna carrier structure passes through the through opening of the second reflective plate to guide a coaxial cable that is electrically connected to the millimeter wave antenna module;
wherein a wavelength of the original millimeter wave signal is between 1 mm and 10 mm, and a frequency of the original millimeter wave signal is between 28 GHz and 300 GHz;
wherein the first reflective plate has a first diameter between 10 mm and 40 mm, and a first height between 20 mm and 80 mm;
wherein the second reflective plate has a second diameter between 100 mm and 200 mm, and a second height between 20 mm and 80 mm; and
wherein the second diameter of the second reflective plate is greater than the first diameter of the first reflective plate, and the first diameter of the first reflective plate is greater than or equal to a maximum width of the millimeter wave antenna module, and the maximum width of the millimeter wave antenna module is greater than, equal to, or less than an opening diameter of the through opening of the second reflective plate.

6. The high-gain millimeter wave antenna structure according to claim 4,
wherein the millimeter wave antenna module includes a millimeter wave antenna and at least one focusing lens, and the millimeter wave antenna includes at least one microstrip patch antenna unit;
wherein the millimeter wave antenna is disposed within a first lens focusing area of the at least one focusing lens, and the first reflective plate is disposed within a second lens focusing area of the at least one focusing lens;
wherein the millimeter wave antenna is disposed between the at least one focusing lens and the second reflective plate, and the at least one focusing lens is disposed between the millimeter wave antenna and the first reflective plate;
wherein the at least one focusing lens is configured as a ceramic focusing lens, a mica focusing lens, a glass focusing lens or a plastic focusing lens, and the at least one focusing lens has a thickness between 1000 μm and 3000 μm;
wherein the first recessed area of the first reflective plate has a protruding tip portion and a first signal reflective surface surrounding the protruding tip portion;
wherein the second reflective plate has a through opening connected to the second recessed area, and the second recessed area of the second reflective plate has a second signal reflective surface surrounding the through opening;
wherein, when the antenna array module of the millimeter wave antenna module is configured to optionally provide the original millimeter wave signal, the original millimeter wave signal provided by the millimeter wave antenna module passes through the at least one focusing lens and is reflected by the first signal reflective surface of the first reflective plate and the second signal reflective surface of the second reflective plate in sequence to form the operating millimeter wave signal transmitted in the same predetermined direction;
wherein the millimeter wave antenna module is disposed inside the second recessed area of the second reflective plate, and the millimeter wave antenna module is supported by an antenna carrier structure to be disposed between the first reflective plate and the second reflective plate;
wherein the antenna carrier structure passes through the through opening of the second reflective plate to guide a coaxial cable that is electrically connected to the millimeter wave antenna module;
wherein a wavelength of the original millimeter wave signal is between 1 mm and 10 mm, and a frequency of the original millimeter wave signal is between 28 GHz and 300 GHz;
wherein the first reflective plate has a first diameter between 10 mm and 40 mm, and a first height between 20 mm and 80 mm;
wherein the second reflective plate has a second diameter between 100 mm and 200 mm, and a second height between 20 mm and 80 mm; and
wherein the second diameter of the second reflective plate is greater than a lens diameter of the at least one focusing lens, the lens diameter of the at least one focusing lens is greater than the first diameter of the first reflective plate, the first diameter of the first reflective plate is greater than or equal to a maximum width of the millimeter wave antenna module, and the maximum width of the millimeter wave antenna module is greater than, equal to, or smaller than an opening diameter of the through opening of the second reflective plate.

7. A millimeter wave antenna module, comprising a millimeter wave antenna and at least one focusing lens, wherein the millimeter wave antenna is disposed within a first lens focusing area of the at least one focusing lens.

8. The millimeter wave antenna module according to claim 7,
wherein the millimeter wave antenna includes at least one microstrip patch antenna unit; and
wherein the at least one focusing lens is configured as a ceramic focusing lens, a mica focusing lens, a glass focusing lens or a plastic focusing lens, and the at least one focusing lens has a thickness between 1000 μm and 3000μ m.

9. The millimeter wave antenna module according to claim 7,
wherein the millimeter wave antenna module is disposed between a first reflective plate and a second reflective plate;
wherein the first reflective plate has a first recessed area, and the second reflective plate has a second recessed area;
wherein the first reflective plate and the second reflective plate are arranged correspondingly, the first recessed area of the first reflective plate is smaller than the second recessed area of the second reflective plate, and the first recessed area of the first reflective plate faces the second recessed area of the second reflective plate;
wherein the first reflective plate has a first focusing area, and the millimeter wave antenna module is disposed within the first focusing area of the first reflective plate;
wherein the second reflective plate has a second focusing area, and the first reflective plate is disposed within the second focusing area of the second reflective plate;
wherein, when the millimeter wave antenna module is configured to optionally provide an original millimeter wave signal, the original millimeter wave signal provided by the millimeter wave antenna module is reflected by the first reflective plate and the second reflective plate in sequence to form an operating millimeter wave signal transmitted in a same predetermined direction; and
wherein an operating antenna gain of the operating millimeter wave signal provided by the cooperation of the millimeter wave antenna module, the first reflective plate and the second reflective plate is greater than an original antenna gain of the original millimeter wave signal provided by the millimeter wave antenna module.

10. The millimeter wave antenna module according to claim 9,
wherein the first reflective plate is disposed within a second lens focusing area of the at least one focusing lens;
wherein the millimeter wave antenna is disposed between the at least one focusing lens and the second reflective plate, and the at least one focusing lens is disposed between the millimeter wave antenna and the first reflective plate;
wherein the first recessed area of the first reflective plate has a protruding tip portion and a first signal reflective surface surrounding the protruding tip portion;
wherein the second reflective plate has a through opening connected to the second recessed area, and the second recessed area of the second reflective plate has a second signal reflective surface surrounding the through opening;
wherein, when the antenna array module of the millimeter wave antenna module is configured to optionally provide the original millimeter wave signal, the original millimeter wave signal provided by the millimeter wave antenna module passes through the at least one focusing lens and is reflected by the first signal reflective surface of the first reflective plate and the second signal reflective surface of the second reflective plate in sequence to form the operating millimeter wave signal transmitted in the same predetermined direction;
wherein the millimeter wave antenna module is disposed inside the second recessed area of the second reflective plate, and the millimeter wave antenna module is supported by an antenna carrier structure to be disposed between the first reflective plate and the second reflective plate;
wherein the antenna carrier structure passes through the through opening of the second reflective plate to guide a coaxial cable that is electrically connected to the millimeter wave antenna module;
wherein a wavelength of the original millimeter wave signal is between 1 mm and 10 mm, and a frequency of the original millimeter wave signal is between 28 GHz and 300 GHz;
wherein the first reflective plate has a first diameter between 10 mm and 40 mm, and a first height between 20 mm and 80 mm;
wherein the second reflective plate has a second diameter between 100 mm and 200 mm, and a second height between 20 mm and 80 mm; and
wherein the second diameter of the second reflective plate is greater than a lens diameter of the at least one focusing lens, the lens diameter of the at least one focusing lens is greater than the first diameter of the first reflective plate, the first diameter of the first reflective plate is greater than or equal to a maximum width of the millimeter wave antenna module, and the maximum width of the millimeter wave antenna module is greater than, equal to, or smaller than an opening diameter of the through opening of the second reflective plate.
